(19) United States
(12) Patent Application Publication
(10) Pub. No.: US 2026/0121424 A1
(43) Pub. Date: Apr. 30, 2026

(54) BATTERY SYSTEM

(71) Applicant: TOYOTA JIDOSHA KABUSHIKI KAISHA, Toyota-shi (JP)

(72) Inventor: Masakazu HABU, Toyota-shi (JP)

(73) Assignee: TOYOTA JIDOSHA KABUSHIKI KAISHA, Toyota-shi (JP)

(21) Appl. No.: 19/247,255

(22) Filed: Jun. 24, 2025

(30) Foreign Application Priority Data
Oct. 29, 2024 (JP) 2024-189557

(51) Int. Cl. H02J 7/00; H02M 3/155

(52) U.S. Cl. CPC H02J 7/50; H02J 7/62; H02J 7/80; H02J 7/855; H02J 7/94; H02M 3/155

(57) ABSTRACT

Each of battery packs includes first and second current detectors that detect a current flowing through a battery stack. When detected values of the first and second current detectors in one battery pack do not match, exchange of electric power between that battery pack and another one battery pack is performed by a control device causing a DC-to-DC converter corresponding to each battery pack to operate. During operation of the DC-to-DC converter, the control device compares the detected values of the first and second current detectors in the one battery pack with the detected value of the first current detector in the other one battery pack, and selects a normal current detector from the first and second current detectors in the one battery pack.

### CROSS-REFERENCE TO RELATED APPLICATION

This application claims priority to Japanese Patent Application No. 2024-189557 filed on Oct. 29, 2024. The disclosure of the above-identified application, including the specification, drawings, and claims, is incorporated by reference herein in its entirety.

### BACKGROUND

### 1. Technical Field

The present disclosure relates to a battery system, and more particularly to technology for detecting an abnormality in a current detector that is disposed in a battery system that is configured including a plurality of battery packs connected in parallel.

### 2. Description of Related Art

Japanese Unexamined Patent Application Publication No. 2020-16493 (JP 2020-16493 A) discloses a current measuring device that is equipped with three or more current sensors that measure a current of a battery. The current measuring device includes an average value calculation unit that calculates an average value of measurement values from three or more current sensors, and sets the average value that is calculated as the current of the battery. The current measuring device also includes a malfunction determination unit that compares the measurement values of the three or more current sensors with each other, and determines that a current sensor that has measured a measurement value, of which difference as to measurement values of the other current sensors of the three or more current sensors is equal to or greater than a threshold value, is malfunctioning.

### SUMMARY

In a battery system having a plurality of battery packs connected in parallel, a plurality of DC-to-DC converters is provided corresponding to the battery packs, respectively. In such a battery system, a current detector is provided for each of the battery packs, and each of the DC-to-DC converters controls charging and discharging of the corresponding battery pack based on a detected value of the current detector. A plurality of current detectors will be disposed throughout the battery system.

In the battery system described above, the detected values of the current detectors may differ from each other, due to reasons such as variance in control occurring among the DC-to-DC converters, and so forth. Accordingly, even when the detected values of the current detectors are compared with each other as in JP 2020-16493 A, this does not enable malfunctioning of the current detectors to be determined. Accordingly, there is a concern that reliability of the detected values of the current detectors will be low.

The present disclosure has been made to solve such problems, and an object of the present disclosure is to improve the reliability of detected values of current detectors that are disposed for each battery pack in a battery system that is configured including multiple battery packs that are connected in parallel.

According to one aspect of the present disclosure, a battery system that performs charging and discharging between the battery system and an external system includes a plurality of battery packs connected the external system, in parallel to each other, a plurality of DC-to-DC converters, and a control device that controls the DC-to-DC converters. The DC-to-DC converters are provided corresponding to the battery packs, respectively, each of which performs direct current voltage conversion between a corresponding battery pack and the external system. Each of the battery packs includes a battery stack, a first current detector for detecting a current flowing through the battery stack, and a second current detector connected in series with the first current detector, for detecting the current flowing through the battery stack.

When a detected value of the first current detector and a detected value of the second current detector do not match in any one battery pack from among the battery packs, the control device causes the DC-to-DC converters corresponding to each of the any one battery pack and another one battery pack to operate so as to exchange electric power between the any one battery pack and the other one battery pack. The control device selects a normal current detector from the first and second current detectors in the any one battery pack, by comparing the detected values of the first and second current detectors in the any one battery pack with the detected value of the first current detector in the other one battery pack, during operation of the DC-to-DC converter.

According to the present disclosure, in a battery system that is configured including a plurality of battery packs connected in parallel, reliability of detected values of current detectors that are disposed for each battery pack can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery system according to an embodiment of the present disclosure;

FIG. 2 is a diagram illustrating a configuration of a battery module;

FIG. 3 is a diagram for describing an abnormality detection mode of the battery system;

FIG. 4 is a flowchart for describing procedures of abnormality detection processing in a current detector by a control device; and

FIG. 5 is a flowchart for describing a modification of abnormality detection processing in the current detector by the control device.

### DETAILED DESCRIPTION OF EMBODIMENTS

An embodiment of the present disclosure will be described in detail below with reference to the drawings. Note that the same or equivalent portions in the drawings are denoted by the same reference symbols, and description of such portions will not be repeated.

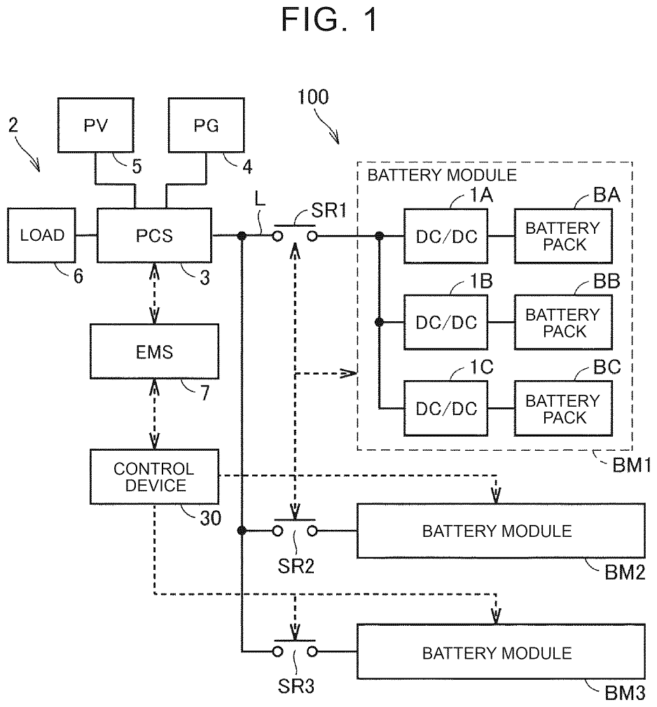

FIG. 1 is a schematic configuration diagram of a battery system according to the embodiment of the present disclosure. As illustrated in FIG. 1, a battery system 100 according to the present embodiment is connected to an external system 2 via a power line L. The battery system 100 can receive power feed from the external system 2, and can also discharge power to the external system 2. The battery system 100 is applied to, for example, a stationary power storage system that is installed in premises of a consumer.

The battery system 100 includes a plurality of battery modules BM1 to BM3, a plurality of sub-relays SR1 to SR3, and a control device 30. Hereinafter, the battery modules BM1 to BM3 will also be collectively referred to as “battery modules BM”, and the sub-relays SR1 to SR3 will also be collectively referred to as “sub-relays SR”. In the example in FIG. 1, the battery system 100 includes three battery modules BM and three sub-relays SR, but the number of each of the battery modules BM and the sub-relays SR is optional, and may be singular.

The battery modules BM1 to BM3 are connected to the external system 2, in parallel to each other. The sub-relays SR1 to SR3 are provided corresponding to the battery modules BM1 to BM3, respectively. The sub-relays SR are controlled by the control device 30 to connect or disconnect the corresponding battery modules BM and the external system 2. In one scenario, when the battery system 100 is started up, the sub-relays SR are turned on, and corresponding battery modules BM are connected to the external system 2. When a malfunction occurs in the corresponding battery module BM, the sub-relay SR is turned off and the corresponding battery module BM is disconnected from the external system 2.

The battery module BM1 includes a plurality of battery packs BA to BC and a plurality of direct current (DC)-to-DC converters 1A to 1C. Hereinafter, the battery packs BA to BC will also be collectively referred to as “battery pack B”, and the DC-to-DC converters 1A to 1C will also be collectively referred to as “DC-to-DC converter 1”. In the example in FIG. 1, the battery module BM1 includes three battery packs B and three DC-to-DC converters 1, but it is sufficient for the number of each of the battery packs B and the DC-to-DC converters 1 to be plural.

The battery packs BA to BC are connected to the external system 2 via the sub-relay SR1, in parallel to each other. Each of the battery packs B includes a battery stack.

The DC-to-DC converters 1A to 1C are provided corresponding to the battery packs BA to BC, respectively. The DC-to-DC converters 1 control charging and discharging of the corresponding battery packs B by executing direct current voltage conversion between the corresponding battery pack B and the external system 2. Specifically, each of the DC-to-DC converters 1 is configured including a step-up circuit and a step-down circuit. The step-up circuit steps up direct current voltage of the corresponding battery pack B and outputs stepped-up voltage, which is the voltage after stepping up, to the external system 2, thereby controlling discharging of the corresponding battery pack B. The step-down circuit steps down direct current voltage from the external system 2 and outputs stepped-down voltage, which is the voltage after stepping down, to the corresponding battery pack B, thereby controlling charging of the corresponding battery pack B. The step-up circuit and the step-down circuit are realized by, for example, a bidirectional chopper.

Although omitted from illustration, the configuration of each of the battery modules BM2 and BM3 is the same as the configuration of the battery module BM1.

The external system 2 is configured including a power conditioning system (PCS) 3, a power grid (PG) 4, a photovoltaic power generation system (PV) 5, a load 6, and an energy management system (EMS) 7. The PCS 3 includes a power conversion device that is capable of both alternating current (AC)-to-DC conversion, and DC-to-AC conversion. The PCS 3 converts, for example, direct current electric power from the photovoltaic power generation system 5 or the battery system 100 into alternating current electric power, and performs supply thereof to the load 6. The load 6 is an electrical appliance that is installed in premises of a consumer, such as for example, an air conditioner, a lighting fixture, or the like. The PCS 3 exchanges alternating current electric power with the power grid 4. The power grid 4 is not limited to a large-scale power grid that is maintained as an infrastructure, and may be a microgrid.

The EMS 7 collaborates with the PCS 3 to manage a state of energy usage in the premises of the consumer. The EMS 7 includes home EMSs (HEMS), building EMSs (BEMS), factory EMSs (FEMS), and so forth. The EMS 7 includes a processor and memory.

The control device 30 includes a processor and memory, and controls the battery system 100 under commands that are received from the EMS 7. The control device 30 controls the sub-relays SR1 to SR3, and also controls the DC-to-DC converters 1A to 1C in each of the battery modules BM.

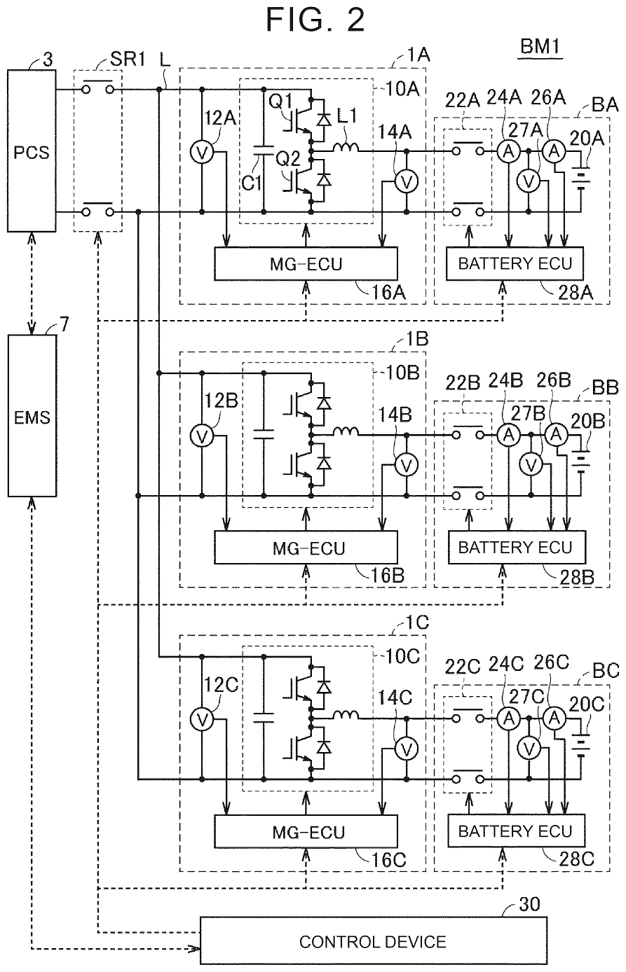

FIG. 2 is a diagram illustrating a configuration of the battery module BM. FIG. 2 representatively illustrates a configuration of the battery module BM1. As illustrated in FIG. 2, the DC-to-DC converter 1A includes a bidirectional chopper 10A, voltage detectors 12A and 14A, and a motor generator electronic control unit (MG ECU) 16A. The DC-to-DC converter 1B includes a bidirectional chopper 10B, voltage detectors 12B and 14B, and an MG ECU 16B. The DC-to-DC converter 1C includes a bidirectional chopper 10C, voltage detectors 12C and 14C, and an MG ECU 16C. Hereinafter, the bidirectional choppers 10A to 10C will also be collectively referred to as “bidirectional choppers 10”, the voltage detectors 12A to 12C will also be collectively referred to as “voltage detectors 12”, and the voltage detectors 14A to 14C will also be collectively referred to as “voltage detectors 14”.

The bidirectional chopper 10 is a well-known device that includes a plurality of semiconductor switching devices. In the example in FIG. 2, each of the bidirectional choppers 10 includes a reactor L1 as an energy storage element, two semiconductor switching devices Q1 and Q2 that are connected in series, and a smoothing capacitor C1. The bidirectional chopper 10 steps up the direct current voltage of the corresponding battery pack B, and outputs the stepped-up voltage, which is the voltage after stepping up, to the external system 2. Also, the bidirectional chopper 10 steps down the direct current voltage from the external system 2, and outputs the stepped-down voltage, which is the voltage after stepping down, to the corresponding battery pack B.

The voltage detector 14 detects the voltage (the direct current voltage of the battery pack B) before stepping up by the bidirectional chopper 10, and outputs a signal indicating a detected value. The voltage detector 12 detects the stepped-up voltage, which is the voltage after stepping up by the bidirectional chopper 10, and outputs a signal indicating the detected value.

The MG ECU 16 is a device that controls communication between the bidirectional chopper 10 and the control device 30, and includes a processor and memory. Each of the MG ECUs 16 transmits output signals of the voltage detectors 12 and 14 to the control device 30. Also, the MG ECU 16 receives a control signal for controlling the bidirectional chopper 10 from the control device 30. The bidirectional chopper 10 executes direct current voltage conversion in accordance with a control signal from the control device 30.

The battery pack BA includes a battery stack 20A, a relay 22A, current detectors 24A and 26A, a voltage detector 27A, and a battery ECU 28A. The battery pack BB includes a battery stack 20B, a relay 22B, current detectors 24B and 26B, a voltage detector 27B, and a battery ECU 28B. The battery pack BC includes a battery stack 20C, a relay 22C, current detectors 24C and 26C, a voltage detector 27C, and a battery ECU 28C. Hereinafter, the battery stacks 20A to 20C will also be collectively referred to as “battery stacks 20”, and the relays 22A to 22C will also be collectively referred to as “relays 22”. The current detectors 24A to 24C will also be collectively referred to as “current detectors 24”, the current detectors 26A to 26C will also be collectively referred to as “current detectors 26”, the voltage detectors 27A to 27C will also be collectively referred to as “voltage detectors 27”, and the battery ECUs 28A to 28C will also be collectively referred to as “battery ECUs 28”.

Each of the battery stacks 20 is an assembled battery in which a plurality of single batteries (battery cells) is connected in series, for example. The battery cells may be, for example, ternary lithium-ion batteries, or may be iron phosphate lithium-ion batteries. The battery cells may also be nickel metal hydride batteries. The battery pack B may be a repurposed battery pack that was installed in an electrified vehicle. The battery pack B may include a single cell instead of the assembled battery.

Each of the relays 22 is controlled by the battery ECU 28 to connect or disconnect the battery stack 20 and the DC-to-DC converter 1.

Each of the current detectors 24 detects the current flowing through the battery stack 20, and outputs a signal indicating the detected value. Each of the current detectors 26 is connected in series with the current detector 24, detects the current flowing through the battery stack 20, and outputs a signal indicating the detected value.

The detected value of the current flowing through the battery stack 20 is used to calculate electric power charged to and discharged from the battery stack 20. In order to improve the reliability of the charge/discharge control of the battery stack 20, it is necessary to detect the current flowing through the battery stack 20 with high accuracy. Accordingly, in the present embodiment, the current detector for detecting the current flowing through the battery stack 20 is a duplex system of the current detectors 24 and 26, thereby ensuring detection accuracy of the current flowing through the battery stack 20. The current detector 24 corresponds to an embodiment of “first current detector”, and the current detector 26 corresponds to an embodiment of “second current detector”.

Each of the voltage detectors 27 detects the voltage of the battery stack 20, and outputs a signal indicating the detected value. The battery pack B is further provided with a temperature detector for detecting temperature of the battery stack 20, although omitted from illustration.

Each of the battery ECUs 28 includes a processor and memory, and monitors the corresponding battery stack 20. The battery ECU 28 transmits output signals from the current detectors 24 and 26, the voltage detector 27, and the temperature detector, to the control device 30. Also, the battery ECU 28 calculates a State Of Charge (SOC) of the battery stack 20, based on the output signals of the voltage detector 27 and the current detectors 24 and 26, and transmits a signal indicating the SOC that is calculated to the control device 30. Also, the battery ECU 28 controls the relay 22 in accordance with control signals that are provided from the control device 30.

Next, operation of the battery system 100 according to the present embodiment will be described.

The battery system 100 according to the present embodiment has a normal operation mode in which charging and discharging is performed between the battery system 100 and the external system 2, and an abnormality detection mode for detecting an abnormality in the current detectors 24 and 26.

In the normal operation mode, the control device 30 receives commands from the EMS 7 and controls the battery modules BM1 to BM3. In the present embodiment, the control device 30 executes droop control in each battery module BM. Specifically, the control device 30 controls the charging and discharging of the corresponding battery pack B in each of the multiple DC-to-DC converters 1A to 1C such that the stepped-up voltage, which is voltage after stepping up by each of the bidirectional choppers 10, matches a target voltage. In one scenario, the control device 30 calculates voltage deviation between a target voltage and a detected value of the stepped-up voltage that is detected by the voltage detector 12, and then determines electric power to be charged to the corresponding battery pack B, and electric power to be discharged from the corresponding battery pack B, in proportion to the voltage deviation that is calculated.

In this way, in the normal operation mode, droop control is performed in each of the DC-to-DC converters 1A to 1C, and the charging and discharging of the corresponding battery pack B is controlled such that the stepped-up voltage matches the target voltage. In the droop control, the control device 30 calculates the electric power to be charged to and discharged from the corresponding battery pack B, based on the output signals of the current detectors 24 and 26, and of the voltage detector 27, that are provided by the battery ECU 28. The control device 30 controls the charging and discharging of the corresponding battery pack B such that the electric power that is calculated does not exceed a power limit value that is set to suppress malfunctioning of the battery pack B.

In the above configuration, when the current detectors 24 and 26 making up the duplex system are both normal, the detected value of the current detector 24 and the detected value of the current detector 26 match. In this case, the control device 30 determines that the detected values of the current detectors 24 and 26 are true values of the current flowing through the battery pack B, and uses these detected values to calculate the electric power charged to and discharged from the battery pack B.

On the other hand, in a case of one of the current detectors 24 and 26 malfunctioning, the detected value of the current detector 24 and the detected value of the current detector 26 will no longer match. In this case, the control device 30 determines that the detected value of one of the current detectors 24 and 26 is not the true value of the current flowing through the battery pack B. However, which of the current detectors 24 and 26 has malfunctioned cannot be distinguished.

For battery pack B in which the detected values of the current detectors 24 and 26 do not match, the control device 30 determines that reliability of the detected values is low, and stops operation of the corresponding DC-to-DC converter 1, thereby stopping use of battery pack B itself. In this case, however, the use of the battery pack B will be restricted even though the other one of the current detectors 24 and 26 is normal.

Accordingly, in the present embodiment, the abnormality detection mode for detecting abnormalities in the current detectors 24 and 26 is provided. In the abnormality detection mode, in the battery pack B in which the detected values of the current detectors 24 and 26 do not match, the normal current detector is selected from between the current detectors 24 and 26 using the method described below. In the normal operation mode after the abnormality detection mode, the charging and discharging of this battery pack B is controlled using the detected value of the normal current detector that is selected. This enables continuing to use this battery pack B using the detected value of the normal current detector.

During execution of the normal operation mode, the control device 30 determines whether a malfunction has occurred in the current detectors 24 and 26 in each of the battery modules BM1 to BM3, based on the output signals of the current detectors 24 and 26 that are provided from each of the battery packs B. Specifically, the control device 30 determines, for each battery pack B, whether the detected value of the current detector 24 and the detected value of the current detector 26 match each other. When the detected value of the current detector 24 and the detected value of the current detector 26 of all battery packs BA to BC match in the battery module BM, the control device 30 determines that the current detectors 24 and 26 of this battery module BM are normal. When the current detectors 24 and 26 of all the battery modules BM1 to BM3 are normal, the control device 30 continues to execute the normal operation mode.

On the other hand, when a battery pack B is detected in any battery module BM among the battery modules BM1 to BM3 in which the detected value of the current detector 24 does not match the detected value of the current detector 26, the control device 30 determines that one of the current detectors 24 and 26 of this battery pack B is malfunctioning. In this case, the control device 30 stops the operation of the DC-to-DC converter 1 corresponding to the battery pack B that includes the current detector that is malfunctioning. The control device 30 then transitions the battery system 100 from the normal operation mode to the abnormality detection mode.

The EMS 7 stops the operation of the PCS 3 in accordance with the battery system 100 transitioning to the abnormality detection mode. In one scenario, when the battery system 100 transitions to the abnormality detection mode, a user (consumer) of the battery system 100 can perform an operation on the EMS 7 to select the abnormality detection mode during a time period when the battery system 100 is not charging from or discharging to the external system 2. Upon receiving this operation, the EMS 7 stops the operation of the PCS 3, thereby stopping the exchange of electric power between the external system 2 and the battery system 100.

Next, the control device 30 stops the operation of the DC-to-DC converters 1A to 1C in the other battery modules BM in which the current detectors 24 and 26 are normal. Note that in the abnormality detection mode, the control device 30 maintains all of the sub-relays SR1 to SR3 in the on state. This is because in a configuration in which the sub-relay SR corresponding to the battery module BM in which a malfunction has occurred in the current detectors 24 and 26 is turned off during the abnormality detection mode, and the sub-relay SR is turned on after the abnormality detection mode ends, an overcurrent will flow due to difference in step-up voltage between the battery modules BM1 to BM3 when the sub-relay SR is turned on, and this may cause fusing of this sub-relay SR.

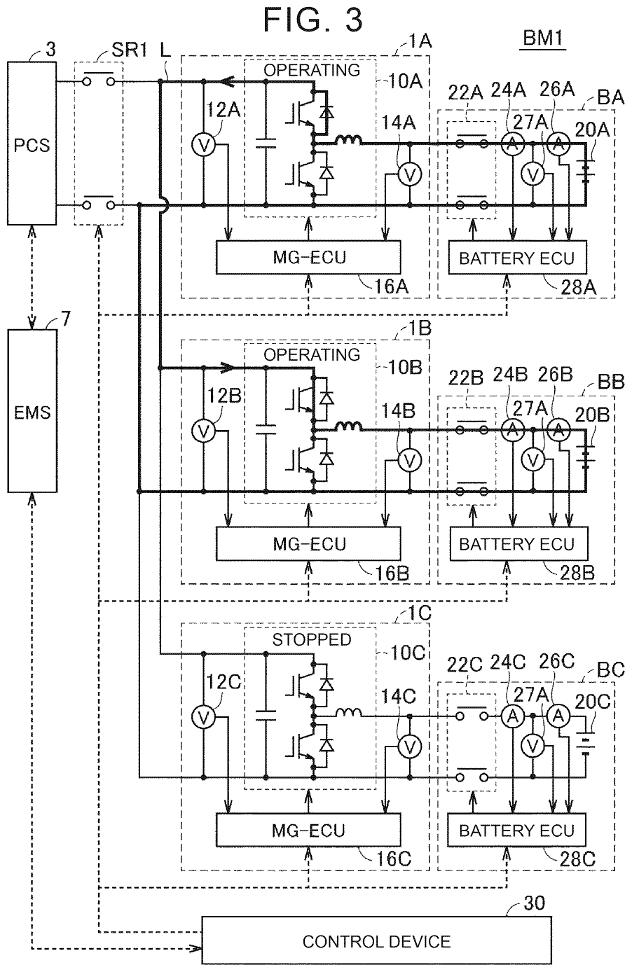

FIG. 3 is a diagram for describing the abnormality detection mode of the battery system 100. In FIG. 3, a case is assumed in which a malfunction occurs in the current detectors 24A and 26A in the battery pack BA of the battery module BM1. The battery modules BM2 and BM3 in which the current detectors 24 and 26 are normal are omitted from illustration.

As illustrated in FIG. 3, when a malfunction occurs in the current detectors 24A and 26A in the battery pack BA, the control device 30 operates the DC-to-DC converter 1A corresponding to the battery pack BA and the DC-to-DC converter 1 corresponding to the other one battery pack B.

As for the other one battery pack B, the battery pack B in which the current detectors 24 and 26 are normal is selected from among the battery packs BA to BC. In the example of FIG. 3, the control device 30 operates the DC-to-DC converter 1B corresponding to the battery pack BB. Also, the control device 30 stops the operation of the DC-to-DC converter 1C corresponding to the remaining battery pack B (battery pack BC in FIG. 3) excluding the battery packs BA and BB.

The control device 30 operates the DC-to-DC converters 1A and 1B so as to exchange electric power between the battery pack BA and the battery pack BB. In one scenario, as illustrated in FIG. 3, DC-to-DC converters 1A and 1B are operated to supply electric power from the battery pack BA to the battery pack BB. That is to say, discharging of the battery pack BA and charging of the battery pack BB are executed.

Specifically, the control device 30 controls the bidirectional chopper 10A so as to output the electric power that is stored in the battery pack BA to the power line L, as indicated by a heavy continuous line in FIG. 3. During control of the bidirectional chopper 10A, the current detectors 24A and 26A detect the current (discharge current) flowing through the battery stack 20A, and output signals indicating the detected value.

Also, as indicated by a heavy continuous line in FIG. 3, the control device 30 controls the bidirectional chopper 10B so as to supply electric power that is supplied from the battery pack BA to the battery pack BB, via the bidirectional chopper 10A and the power line L. During control of the bidirectional chopper 10B, the current detectors 24B and 26B detect the current (charging current) flowing through the battery stack 20B, and output signals indicating the detected value.

Upon receiving the output signals of the current detectors 24A and 26A and the output signals of the current detectors 24B and 26B, the control device 30 selects a normal current detector from the current detectors 24A and 26A based on these output signals.

When electric power is supplied from the battery stack 20A to the battery stack 20B as illustrated in FIG. 3, the current (discharging current) flowing through battery stack 20A and the current (charging current) flowing through the battery stack 20B have opposite flow directions (polarities), and are also equal in magnitude. Accordingly, when the current detectors 24A and 26A are normal, the detected values of the current detectors 24A and 26A and the detected values of the current detectors 24B and 26B should be of opposite polarity and equal in absolute value.

The control device 30 compares the detected values of the current detectors 24A and 26A with the detected value of one of the current detectors 24B and 26B, to select a normal current detector from the current detectors 24A and 26A. Specifically, when the detected value (absolute value) of the current detector 24A and the detected value (absolute value) of the current detector 24B match, while the detected value (absolute value) of the current detector 26A and the detected value (absolute value) of the current detector 24B do not match, the control device 30 selects the current detector 24A as being the normal current detector and also determines that the current detector 26A is malfunctioning.

Conversely, when the detected value (absolute value) of the current detector 26A and the detected value (absolute value) of the current detector 24B match, while the detected value (absolute value) of the current detector 24A and the detected value (absolute value) of the current detector 24B do not match, the control device 30 selects the current detector 26A as being the normal current detector and also determines that the current detector 24A is malfunctioning.

In the normal operation mode after the abnormality detection mode ends, the control device 30 controls the charging and discharging of the battery pack BA using the detected value of the normal current detector. This enables the battery pack BA to be used continuously using the detected value of the normal current detector.

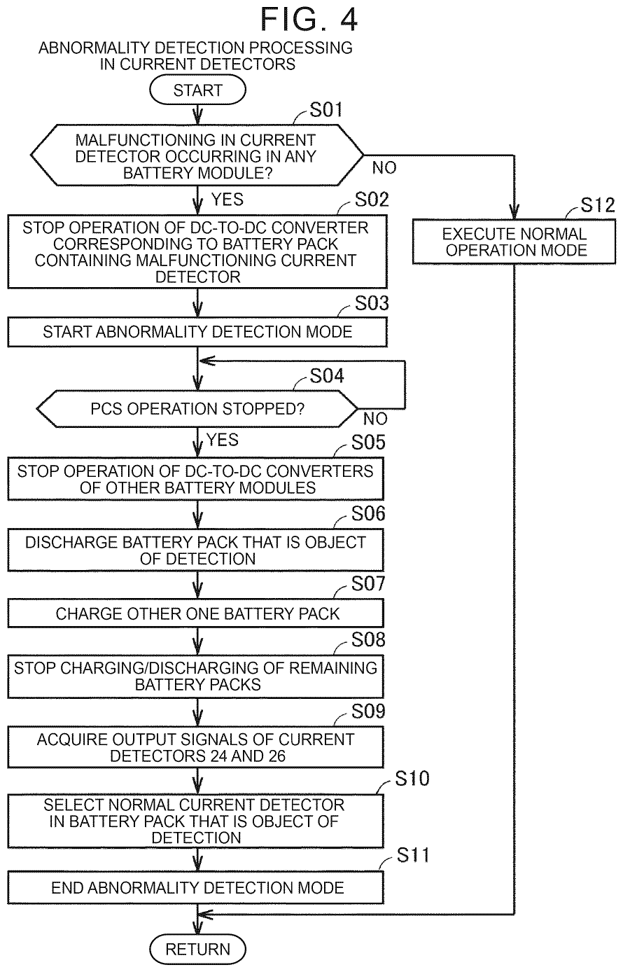

FIG. 4 is a flowchart for describing procedures of abnormality detection processing in the current detectors 24 and 26 by the control device 30. As shown in FIG. 4, during operation of the battery system 100, the control device 30 determines in step S01 whether a malfunction has occurred in one of the current detectors 24 and 26 in any of the battery modules BM1 to BM3. In S01, the control device 30 determines whether a malfunction has occurred in one of the current detectors 24 and 26 of each battery pack B based on the output signals of the current detectors 24 and 26 that are provided from the battery packs BA to BC in each battery module BM.

When the detected values of the current detectors 24 and 26 in each battery pack B in each of the battery modules BM1 to BM3 are the same, the control device 30 determines that the current detectors 24 and 26 are normal in all of the battery modules BM1 to BM3 (determination of NO in S01). In this case, the control device 30 executes the normal operation mode in step S12.

On the other hand, when the detected values of the current detectors 24 and 26 of any of the battery packs BA to BC in any of the battery modules BM1 to BM3 do not match, the control device 30 determines that a malfunction has occurred in one of the current detectors 24 and 26 of these battery packs B (determination of YES in S01). In this case, in step S02, the control device 30 stops the operation of the DC-to-DC converter 1 corresponding to the battery pack B that includes the current detector that malfunctioned. Next, in step S03, the control device 30 starts execution of the abnormality detection mode.

In the abnormality detection mode, the control device 30 first determines in step S04 whether the operation of the PCS 3 has been stopped. In S04, when the EMS 7 receives an operation from the user (consumer) of the battery system 100 to stop the operation of the PCS 3, a determination of YES is made.

When the operation of the PCS 3 is stopped (determination of YES in S04), the control device 30 advances to step S05 and stops the operation of the DC-to-DC converters 1A to 1C in the other battery modules BM that include the normal current detectors 24 and 26.

Next, in order to exchange electric power between the battery pack B including the malfunctioning current detector (hereinafter also referred to as “battery pack B that is object of detection”) and another one battery pack B, the control device 30 operates the DC-to-DC converters 1 corresponding to each of these two battery packs B. In FIG. 4, in step S06, the control device 30 executes discharging of battery pack B that is the object of detection. In S06, the control device 30 controls the bidirectional chopper 10 of the corresponding DC-to-DC converter 1 so as to output to the power line L the electric power that is stored in the battery pack B that is the object of detection. During control of the bidirectional chopper 10, the current detectors 24 and 26 that are included in the battery pack B that is the object of detection detect the current (discharge current) flowing through the battery stack 20, and output a signal indicating the detected value.

Also, control device 30 executes charging of the other one battery pack B in step S07. In S07, the control device 30 controls the bidirectional chopper 10 of the corresponding DC-to-DC converter 1 so as to supply the electric power that is supplied from the battery pack B that is the object of detection to the other one battery pack B. During control of the bidirectional chopper 10, the current detectors 24 and 26 included in the other one battery pack B detect the current (discharge current) flowing through the battery stack 20, and output a signal indicating the detected value.

Further, in step S08, the control device 30 stops charging and discharging of the remaining battery pack B excluding the battery pack B that is the object of detection and the other one battery pack B. In S08, the control device 30 stops the operation of the DC-to-DC converter 1 corresponding to the remaining battery pack B.

Next, in step S09, the control device 30 acquires output signals of the current detectors 24 and 26 from each of the battery pack B that is the object of detection and the other one battery pack B. Then, in step S10, the control device 30 selects a normal current detector from the current detectors 24 and 26 in the battery pack B that is the object of detection, based on the acquired output signals of the current detectors 24 and 26. In S10, the control device 30 selects a normal current detector by comparing the detected values of the current detectors 24 and 26 of the battery pack B that is the object of detection with the detected value of the current detector 24 (or current detector 26) of the other one battery pack B.

When the normal current detector is selected, the control device 30 ends the abnormality detection mode in step S11. In the normal operation mode after the abnormality detection mode ends, the control device 30 controls the charging and discharging of the battery pack B that is the object of detection, using the detected value of the normal current detector.

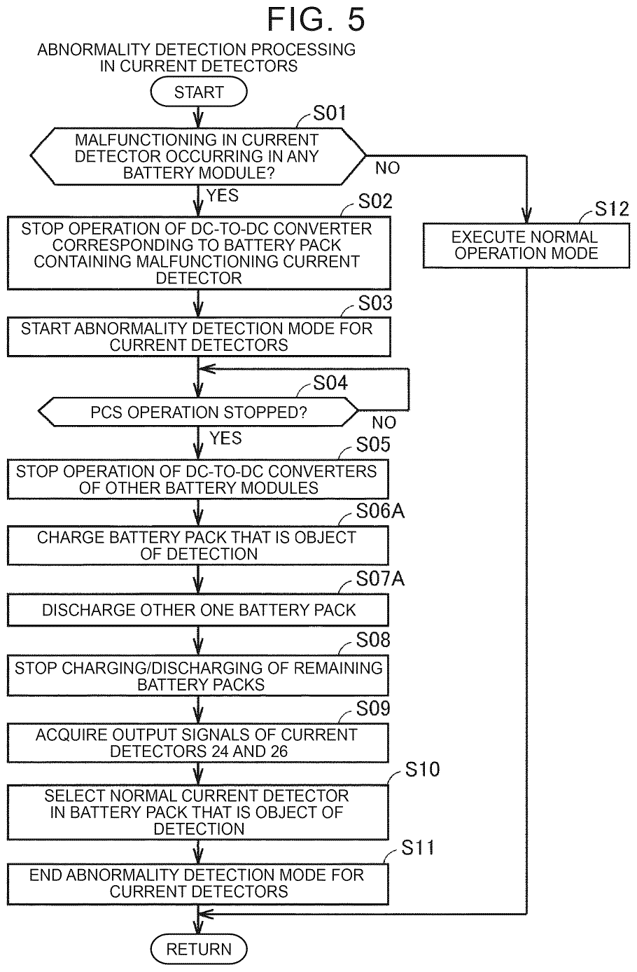

Note that in FIG. 4, a configuration has been described in which, in the abnormality detection processing, discharging of the battery pack B that is the object of detection is executed (step S06), and charging of the other one battery pack B is executed (step S07). However, in the present disclosure, it is sufficient to operate the DC-to-DC converter 1 corresponding to each battery pack B so as to exchange electric power between the battery pack B that is the object of detection and the other one battery pack B. Therefore, as shown in the flowchart of FIG. 5, a configuration may be made in which the charging of the battery pack B that is the object of detection is executed (step S06A), and the discharging of another one battery pack B is executed (step S07A).

According to the present embodiment, in a battery system that is configured including multiple battery packs that are connected in parallel, reliability of detected values of the current detectors that are disposed in duplex in each battery pack can be improved. Thus, even in a case in which one of the current detectors that are disposed in duplex happens to malfunction, the corresponding battery pack can continue to be used by using the detected value of the normal current detector.

The embodiment disclosed herein should be considered to be exemplary in all respects and not restrictive. The scope of the present disclosure is indicated by the claims rather than the description of the embodiment described above, and it is intended that all changes within the meaning and scope equivalent to the claims are included.

What is claimed is:

1. A battery system regarding which charging and discharging between the battery system and an external system is performed, the battery system comprising:
a plurality of battery packs connected the external system, in parallel to each other;
a plurality of DC-to-DC converters provided corresponding to the battery packs respectively, each of which performs direct current voltage conversion between a corresponding battery pack and the external system; and
a control device that controls the DC-to-DC converters, wherein
each of the battery packs includes
a battery stack,
a first current detector for detecting a current flowing through the battery stack, and
a second current detector connected in series with the first current detector, for detecting the current flowing through the battery stack, and
when a detected value of the first current detector and a detected value of the second current detector do not match in any one battery pack from among the battery packs, the control device
causes the DC-to-DC converters corresponding to each of the any one battery pack and another one battery pack to operate so as to exchange electric power between the any one battery pack and the other one battery pack, and
selects a normal current detector from the first and second current detectors in the any one battery pack, by comparing the detected values of the first and second current detectors in the any one battery pack with the detected value of the first current detector in the other one battery pack, during operation of the DC-to-DC converter.

2. The battery system according to claim 1, wherein
when the detected value of the first current detector in the any one battery pack matches the detected value of the first current detector in the other one battery pack, the control device selects the first current detector in the any one battery pack as being the normal current detector, and
when the detected value of the second current detector in the any one battery pack matches the detected value of the first current detector in the other one battery pack, the control device selects the second current detector in the any one battery pack as being the normal current detector.

3. The battery system according to claim 1, wherein, when the normal current detector is selected, the control device operates the DC-to-DC converter corresponding to the any one battery pack using the detected value of the normal current detector.

4. The battery system according to claim 1, wherein
the external system includes a power conversion device that performs bidirectional electric power conversion between a power grid and the battery system,
when the detected value of the first current detector and the detected value of the second current detector do not match in the any one battery pack among the battery packs, operation of the power conversion device is stopped, and
the control device causes the DC-to-DC converters corresponding to the any one battery pack and the other one battery pack to operate, while operation of the power conversion device is stopped.
